(19) United States
(12) Patent Application Publication
(10) Pub. No.: US 2011/0136517 A1
(43) Pub. Date: Jun. 9, 2011

(54) OPTIMIZED PAGING OF A USER EQUIPMENT

(75) Inventors: Heikki Juhani Seppalainen, Espoo (FI); Kati Marita Vainola, Hikia (FI)

(73) Assignee: NOKIA SIEMENS NETWORKS OY, ESPOO (FI)

(21) Appl. No.: 13/057,804

(22) PCT Filed: Aug. 7, 2008
(86) PCT No.: PCT/EP08/60415

§ 371 Date: Feb. 7, 2011

(51) Int. Cl. H04W 68/02

(52) U.S. Cl. 455/458

(57) ABSTRACT

It is described a method for paging a user equipment (107) within the telecommunication network. The method comprises selecting an optimized area (113) within a location area (111) being assigned to the user equipment (107), wherein at least two base stations (105A, 105B) are assigned to the optimized area (113). Further, the method comprises sending a paging message from a core network element (101, 103) serving the location area (111) to the at least two base stations (105A, 105B). The method also comprises paging the user equipment (107) from the at least two base stations (105A, 105B) being assigned to the optimized area (113). It is further described a base station (105A, 105B), a core network element (101, 103) and a telecommunication network, which are adapted to carry out the described paging method. Also it is described a program element, wherein the program element when being executed by a data processor is adapted for controlling the described paging method.

### FIELD OF INVENTION

The present invention relates to the field of mobile telecommunication networks. In particular the present invention relates to a method for paging a user equipment within a mobile telecommunication network. The present invention also relates to a base station, a core network element and a telecommunication network for implementing the method for paging a user equipment within a telecommunication network.

### ART BACKGROUND

Mobile radio communication systems have progressed through three generations: an analog first generalization, a digital second generation (2G) and the multimedia third generation (3G). It is an objective of the 3rd Generation Partnership Project (3GPP) to provide for technical specification of a globally applicable third generation mobile radio communication system. 3GPP specifications are based on evolved Global System for Mobile Communications (evolved GSM) specifications. The corresponding standardization encompasses a radio network, a core network and a service architecture.

In order a telecommunication network such as a mobile radio communication system being able to operate in a predefined manner, various different functions need to be provided within the telecommunication network. These functions can be divided in different categories. One category comprises functions that relate to an actual transportation of communication such as communication of voice, text, multimedia and/or other data. Another category can be seen as being formed by control and/or management functions. These control and/or management functions include a control of the communication of voice, text, multimedia and/or other data communication. Provisioning of various services for users needs also to be controlled by appropriate control functions.

Signaling of messages associated with different functions is understood as being implemented on different planes or channels. For example, control messages are communicated on a control plane and the actual communication of voice, text, multimedia and/or other data is transported on a user plane. The communication on the user plane can be supported by the signaling of the control messages on the control plane. A skilled person is familiar with principles of dividing various functions into planes, and therefore these principles will not be explained in any greater herein.

Typically, the telecommunication networks provide these functionalities by means of separate channels, e.g. by means of separated signaling and communication channels. Such arrangements are employed e.g. by signaling system 7 (SS7) core networks and Q.931/GSM/WCDMA (Global system for Mobile communication/Wideband Code Division Multiple Access) subscriber access. Therefore the term signaling channel may sometimes be used when referring to control plane communications. Similarly the term communication channel may be also used when referring to user plane communications.

The various functions of the telecommunication networks may have been developed quite independently from each other and may use different rules such as protocols in different communication systems. The 3GPP standards and protocols define e.g. which plane shall be used for a certain purpose.

One of the advantages of any mobile telecommunication network is that subscribers may be reached for an incoming call in any service area as long as a user equipment of the subscriber is powered on and has registered its current location in a location area. In a Universal Mobile Telecommunication System (UMTS) radio access network, for example in a UMTS terrestrial radio access network (UTRAN) specified by technical specifications of 3GPP, the user equipment communicates with the UTRAN via a basis station assigned to his current location area. Mobility management functions including paging user equipments are coordinated by a core network element such as a Mobile Switching Center (MSC), a Serving General Packet Radio Service Support Node (SGSN) and/or a Radio Network Controller (RNC). The core network supports connection-oriented (circuit-switched, CS) services and connectionless (packed-switched, PS) services. The CS services are supported via the MSC, while the PS services are supported via the SGSN.

One network element such as the MSC and/or SGSN serves a number of RNCs. One RNC in turn serves a one Radio Network Sub-system (RNS), which is by definition a geographical area served by one RNC. One RNS is divided in one or more location areas (LA). Hence, at least one location area is served by at least one RNC. There can be more base stations (BS) assigned to one location area. Hence, there can be a number of base stations, which are served—through the RNCs—by one network core element such as the MSC and/or the SGSN.

The communication between the RNC in UTRAN and the core network nodes is typically based on a Radio Access Network Application Protocol (RANAP), wherein RANAP messages are sent over an interface referred to as an Iu interface. Various RANAP procedures implement various RANAP functionalities, for example radio access network management function, relocation functions and paging functions. When a core network element receives a service request, for example a voice call or a short message for a user equipment, the core network element sends a paging message to the RNCs controlling the current location area of the user equipment. The paging message can comprise a user equipment identifier and a location area identifier. The RNCs then broadcast a paging message identifying the corresponding user equipment in the requested location area, which broadcasting will be referred to as a paging the user equipment from the RNCs.

For the purpose of paging user equipments within a telecommunication network, the user equipments provide location updates to the core network elements, for example to the MSC and/or SGSN. A location update occurs every time when the user equipment changes its location area or when a prescribed time period from the last location update has expired. The location update is then carried out in a Visitor Location Register (VLR) which can be an independent core network element, communicating with the MSC via an interface, or can form one unit together with the MSC. In order to reduce the amount of location update information over the Iu interface and prevent the duplication of mobility management functions being performed in both the CS and PS core network elements, a signaling interface (Gs) may be set up between the MSC and the SGSN. Hence, the location updates and the paging of a user equipment within a telecommunication network may be handled through only one of the core network elements, for example the MSC or the SGSN only. The location update is performed based on an Initial UE message, which message is based on the RANAP protocol. The Initial UE message comprises for example a Location Area Code (LAC) indicting the current location area of the user equipment for a CS domain of the core network or a Location Area Identity (LAI) and a Routing Area Code (RAC) for a PS domain of the core network.

A RANAP paging message can be send directly from the MSC via the Iu interface to the RNC controlling the current location area of the paged user equipment using a signaling channel between the circuit-switched MSC and the RNC. Also the RANAP paging message can be send directly from the SGSN via the Iu interface to the RNC controlling the current location area of the paged user equipment using a signaling channel between the packet-switched SGSN and the RNC.

The RANAP paging message can be processed by the SGSN and/or MSC in dependence on a packet mobility management (PMM) state of the paged user equipment. The possible states defined in 3GPP TS 23.060 are: a PMM-detached state a PMM-idle state, and a PMM-connected state.

Alternatively the RANAP paging message can be sent first over the Gs interface from the MSC to the SGSN or vice versa. Afterwards it can be forwarded to the RNC of the UTRAN using the respective PS or CS signaling channel over the Iu interface.

The RANAP protocol format is specified in 3GPP TS 25.413, where also information elements comprised in the RANAP paging message and in the RANAP initial UE message are specified.

The above described paging of a user equipment within a telecommunication network can be used for example within an High Speed Packet Access (HSPA) architecture specified in technical specifications 3GPP Rel-5 and Rel-6 or within an HSPA architecture with a direct tunnel specified in technical specification 3GPP Rel-7. In these technical specifications a collection of HSPA protocols has been defined, which protocols improve the performance of UMTS protocols defined in earlier 3GGP releases. In particular, the 3GPP Rel-5 defines a High Speed Downlink Packet Access (HSDPA) and the 3GPP Rel-6 defines a High Speed Uplink Packet Access (HSUPA). The two HSPA protocol standards provide an increased performance of mobile radio communication systems by using improved modulation schemes and refined protocols. These improvements lead to a better utilization of a radio bandwidth provided by UMTS. The HSDPA provides an improved theoretical downlink performance up to 14.4 Mbit/s and the HSUPA provides an improved theoretical uplink performance up to 5.76 Mbit/s. The number of commercial HSDPA networks, also called 3.5G networks is rapidly growing worldwide, reaching 166 HSPA-enabled networks out 200 UMTS networks by the end of 2007, in a total of 75 countries. Correspondingly, sales of HSPA-enabled user equipments were rising. Telecommunication networks based on the HSPA architecture will be referred to as HSPA networks or HSPA enabled networks.

3GPP Rel-7 brings a further HSPA enhancement significantly improving, for example, on terminal power consumption, 3G coverage area, latency and 3G terminal cost. This enhancement is known as I-HSPA, HSPA evolution, HSPA+ or Internet HSPA.

An all-Internet Protocol (IP) architecture is an option within the I-HSPA, wherein base stations connect to the network via standard gigabit ethernet connected to the internet. This makes the network faster, cheaper to deploy and to operate.

However also a legacy architecture in form of an I-HSPA flat architecture is still possible with the I-HSPA. This flat I-HSPA architecture will be referred to as an I-HSPA architecture in the sequel. In this I-HSPA architecture a communication channel IP can directly communicate from a base station to a Gateway General Packet Radio Service Support Node (GGSN) IP router system using any available link technology. User IP data can by-pass an RNC and an SGSN, the RNC and SGNS being the ones of previous 3GPP UMTS architecture versions. The SGNS can be used only for the signaling channel in the I-HSPA architecture. This is because some of RNC functionalities are taken over by a I-HSPA enabled base station which is referred to as an Enhanced Node B (eNB) or an Intelligent Node B (iNB) and because an optional direct tunneling can be used. Put another way, in the I-HSPA architecture a subset of RNC functions is implemented in the base station and a PS user traffic in the user plane can by-pass the RNC. With an optional direct tunneling the PS user traffic in the user plane can also by-pass the SGSN and communicate directly to the GGSN and/or an intelligent service node (ISN). The base station is communicating to the CS domain of the core network via a standard Iu interface in the control plane over a SIGTRAN protocol. Due to a use of the I-HSPA an I-HSPA related CS enabling handover in the CS core network has to be supported, which from the functionality point of view can be seen as a usual relocation at the signaling channel, for example a Stand-alone Dedicated Control Channel (SDCCH).

The base station is also communicating to the PS domain of the core network via a standard Iu interface in the control plane over the SIGTRAN protocol.

The I-HSPA is fully 3GGP standard compliant, hence standard 3GPP Rel-5/6 user equipments are supported. Another advantage of the I-HSPA is that even though it is a PS optimized solution, operators having existing CS core network still can utilize their investments for speech calls.

As standardized by the technical specification 3GPP Rel-7 the I-HSPA is the flat architecture for Radio Access Networks (RAN) and also for intelligent packet networks. This flat architecture removes bottlenecks, i.e. phenomena where the performance or capacity of the telecommunication network is limited by a single component of the network, unleashing whole Air-interface capabilities for growing PS data traffic needs. This can be seen as capital expenditure (CAPEX) and operational expenditures (OPEX) savings for higher data schemes. With the I-HSPA a mobile operator with 3G license can mobilize existing Digital Subscriber Line (DSL) services and Voice over Internet Protocol (VoIP) services in a profitable manner. Telecommunication networks based on the I-HSPA architecture will be referred to as I-HSPA networks or I-HSPA enabled networks.

The I-HSPA architecture is a major step towards the 3GPP Long Term Evolution (LTE) flat architecture as defined in 3GPP Rel-8. A System Architecture Evolution (SAE) is a core network architecture of the LTE. Similarly to the I-HSPA architecture also here the base station, again referred to as an Enhanced Node B (eNB) or an Intelligent Node B (iNB), has a subset of RNC functions implemented. The PS user traffic in the user plane again by-passes the RNC. With the direct tunneling the PS user traffic in the user plane can also here by-pass a Mobility Management Entity (MME) and communicate directly to an SAE gateway. Telecommunication networks based on the LTE flat architecture will be referred to as LTE networks or LTE enabled networks.

Also within the I-HSPA and LTE enabled mobile telecommunication networks the base station are grouped together and hence assigned to different location areas in order to provide for an optimized signaling in these telecommunication networks. These location areas can be different from the location areas of the former 2G and or 3G mobile telecommunication networks, for example from the location areas of the HSPA networks.

With both the I-HSPA flat architecture and the LTE flat architecture the base stations take over some functionalities of the RNCs of former architectures such as e.g. the HSPA architecture. In particular the paging functions of the RNCs are carried out by the base stations. This means that if the above described paging a user equipment within for example an HSPA telecommunication network is being used also within for example an enabled mobile telecommunication network, a paging message will be send from the core network element such as the MSC and/or the SGSN to each base station within the location area of the user equipment. This is because the paging functions formerly carried out by the RNCs are now carried out by base stations, for example enhanced node Bs. This means that the number of paging messages sent out by the core network element can increase dramatically.

In the following this increase of the paging messages will be illustrated by way of a non-restricting example:

Assume that 750 000 subscribers of a usual 3G telecommunication network, for example of an HSPA network, are served per MSC. Assume further that there are 15 location areas per MSC and that there are 15 RNCs served per MSC so that always one RNC serves one location area. Also assume that during one busy hour (BH) there are 0.4 mobile terminated (MT) calls and 0.66 MT short messages (SMS) per subscriber. Under these assumptions there will be approximately 220 paging messages per second sent from one MSC.

For comparison, assume that the same number of 750 000 subscribers of an I-HSPA network is served per MSC. Assume further that there are 10 location areas per MSC and that there are 4000 enhanced base stations served per MSC. Also assume again that during one busy hour there are 0.4 MT calls and 0.66 MT short messages (SMS) per subscriber. Under these assumptions there will be approximately 88 330 paging messages per second sent from one MSC.

Such a dramatic increase in the number of paging messages sent from core network elements, e.g. MSCs and/or SGSNs, would cause an additional load to these core network elements. It would also cause an increased time and radio network resource consumption as the time and radio network resource consumption is directly proportional to the number of the sent paging messages. The same holds also with respect to BS, MSC and/or SGSN resources. As a result the overall performance of the I-HSPA network will be reduced.

The MSC can already have implemented a functionality to optimize the number of paging messages in a 2G telecommunication network. According to this functionality if there is one location area served by more Base Station Controllers (BSC) the procedure of paging a user equipment within the 2G telecommunication network can be performed only within one BSC area, i.e. one geographical area served by one BSC.

A similar method could be utilized also in the I-HSPA or the LTE network. Such a paging method using only one enhanced node B would provide for a maximum saving capacity with respect to the number of paging messages sent from the core network element. However, due to a small coverage area of one enhanced node B it can very likely be that the user equipment is at the time of paging not anymore in the area covered by the enhanced node B used for paging. This can happen for example when the user equipment is moving at border areas of the area covered by this enhanced node B.

There may be a need for improving the paging procedure for a user equipment in particular within enhanced 3G telecommunication networks like I-HPSA or LTE networks, which paging procedure better utilizes radio network resources and core network resources.

### SUMMARY OF THE INVENTION

This need may be met by the subject matter according to the independent claims. Advantageous embodiments of the present invention are described by the dependent claims.

According to a first aspect of the invention there is provided a method for paging a user equipment within a telecommunication network. The method comprises selecting an optimized area within a location area being assigned to the user equipment, at least two base stations being assigned to the optimized area. The method further comprises sending a paging message from a core network element serving the location area to the at least two base stations. The method also comprises paging the user equipment from the at least two base stations being assigned to the optimized area.

This aspect of the invention is based on the idea that number of paging messages sent from one core element in order a user equipment being paged within a telecommunication network can be decreased if only a subset of all base stations assigned to a location area assigned to the user equipment will be used for paging. Hence, a paging message from the core network element will be sent not to all base stations assigned to the location area but only those base stations assigned to the smaller optimized area within the location area. This can be of importance in particular in connection with evolved network architectures in which some functionalities, for example paging functionalities of radio network controllers, have been moved to the base stations. In such telecommunication networks there might be for example few thousands of base stations served by one core network element, wherein few hundreds of those base stations can be assigned to the same location area.

The location area can either be identical with or independent of a location area, which has already been defined within some existing 2G or 3G network not being based on the enhanced architecture. Hence, with an appropriate selection of the optimized area the number of paging messages can be decreased dramatically since instead of paging messages being sent from the core network element to all base stations assigned to the location area, i.e. hundreds of base station, paging messages can be sent only to a few base stations assigned to the optimized area. Hence, when the core network element receives a service request, for example a voice call or a short message, for the user equipment, the core network element sends a paging message to the base stations assigned to the selected optimized area. The paging message can comprise a user equipment identifier and a location area identifier. These base stations then broadcast a paging message identifying the corresponding user equipment in the requested optimized area, which broadcasting will be referred to as a paging the user equipment from the base stations.

The user equipment may be any type of communication end-device, which is capable of connecting both with a network entity and at least one of neighboring network entities by means of a wireless transmission link. In particular the user equipment may be a cellular mobile phone, a Personal Digital Assistant (PDA), a notebook computer and/or any other movable communication device.

Further, because advantageously at least two base stations are assigned to the optimized area, the effectiveness of the described method will be increased. This may be the case because a coverage area of one base station can be small. Therefore, it can easily happen that the user equipment is at the time of paging not located anymore in the coverage area of a base station, which was serving the user equipment at a moment of its last location update. This can happen for example when the user equipment is moving at border areas of the respective coverage area. To avoid this—and hence to increase the effectiveness of the paging method—at least two base stations are assigned to the optimized area. As a result an optimized procedure for paging a user equipment within enhanced 3G telecommunication networks like I-HPSA or LTE networks is provided. The procedure better utilizes radio network resources, base station resources and core network resources as compared to prior art paging procedures.

According to a further embodiment of the invention the at least two base stations are enhanced node Bs.

With the at least two base stations being enhanced node Bs the method of the present invention can be advantageously implemented within the I-HSPA and/or the LTE enabled communication networks. This can be of importance considering advantageous features of the I-HSPA and/or the LTE telecommunication networks. With the at least two base stations being enhanced node Bs the method of the present invention can be fully compliant with the existing technical specifications of 3GPP Rel-7 and 8. Hence the PS optimized solutions of the I-HSPA and/or the LTE telecommunication networks can be fully utilized. Moreover, operators that have an already existing CS core network still can utilize their investment for speech calls.

According to a further embodiment of the invention the core network element is a mobile switching center (MSC) and/or a serving general packet radio service support node (SGSN).

With the core network element being the MSC the paging method of the present invention can be implemented by using an already existing CS core network. Hence operators already having a CS core network can still utilize their investment for speech calls despite that the described method can most advantageously be used with for example the I-HSPA networks, which networks provide PS optimized solutions. The base station can communicate with a CS domain of the core network via a standard Iu interface in the control plane over a SIGTRAN protocol. Similarly the base station can communicate with a PS domain of the core network via a standard Iu interface in the control plane over for example the SIGTRAN protocol. Here the PS and the CS domain of the core network refer to a packed-switched part and the circuit-switched part of the core network, respectively.

With the core network element being the MSC, the paging message can be sent directly to the at least two base stations, e.g. the enhanced node Bs, over the Iu interface between the CS core network an a UTRAN.

Further, with the core network element being the SGSN the paging method of the present invention can fully use the PS optimized architecture of the I-HSPA networks. When the network core element is the SGSN, the paging message can be sent directly to the at least two base stations, e.g. the enhanced node Bs, over the Iu interface between a PS core network an the UTRAN.

Hence, with the core network element being the MSC and/or the SGSN, the paging method of the present invention can be made fully compliant with the existing technical standards of 3GPP Rel-5, 3GPP Rel-6 and 3GPP Rel-7.

The method of the present invention can be used also within the LTE enabled network, in which case a Mobility Management Entity (MME) can be used instead of the SGSN. Hence the paging method of the present invention can be made fully compliant also with technical standards specified in 3GPP Rel-8.

According to a further embodiment of the invention the paging message is based on a radio access network application protocol (RANAP).

Using the paging message based on the radio access network application protocol (RANAP) is a further step forwards to a full compliance of the method of the present invention with the existing technical specifications of 3GPP. The RANAP protocol format is specified in 3GPP TS 25.413, where also information elements comprised in the RANAP paging message are specified. The RANAP paging message can be processed by the SGSN and/or the MSC in dependence on a packet mobility management (PMM) state of the paged user equipment. The possible states defined in 3GPP TS 23.060 are: a PMM-detached state a PMM-idle state, and a PMM-connected state.

According to a further embodiment of the invention selecting an optimized area comprises sending an initial message from the user equipment to the core network element.

For the method of the present invention to be carried out effectively a properly implemented selection of the optimized area can be of importance. The selection of the optimized area can be based on the initial message sent from the user equipment to the core network element such as the MCS and/or the SGSN via a base station which is serving the user equipment at a moment when the initial message is being sent. Utilizing such an initial message can be of importance for example if the user equipment is moving in a border area of a coverage area of a base station, the base station being served by the core network element.

The initial message can be a part of a location update procedure provided to the core network element by the user equipment. The location update occurs every time when the user equipment changes its location area or when a prescribed time period from the last location update expires. The location update is then carried out in a Visitor Location Register (VLR) which can be an independent core network element or can form one unit together with the MSC.

According to a further embodiment of the invention the initial message is based on a radio access network application protocol.

Using the initial message based on the radio access network application protocol (RANAP) is a further step forwards to a full compliance of the method of the present invention with the existing technical specifications of 3GPP. The RANAP protocol format is specified in 3GPP TS 25.413, where a RANAP initial user equipment message is defined together with the information elements included in the RANAP initial user equipment message.

According to a further embodiment of the invention the initial message comprises an identification information element, the identification information element comprising an information identifying the at least two base stations being assigned to the optimized area.

The identification information element comprising an information identifying the at least two base stations being assigned to the optimized area can be used to further increase effectiveness of the present method. For example a set of neighboring base stations can be defined for each base station by an operator of the telecommunication network in accordance with his needs while optimizing available network resources.

Further, the base station can readily have configured information about all its neighboring base stations. Thus when the initial message is sent from the user equipment to the core network element such as for example the MSC and/or the SGSN and/or the MME via the base station such as for example the enhanced node B, this initial message can be processed by the base station in order to include an information identifying the base station and its neighboring base stations into an identification information element of the initial message. For example the identification information element can be a new paging assistance information element of the initial message based on the RANAP protocol. The paging assistance information element can comprise the identification information identifying the base station in a form of a Radio Network Controller Identifier (RNC-Id) of the base station. Also the paging assistance information element can comprise the identification information identifying the neighboring base stations in a form of RNC-Ids of the neighboring base stations.

In this respect it should be noted that an identification of the base stations such as the enhanced node Bs based on their RNC-Ids is possible due to the fact that some RNC functionalities have been moved to the base stations in the enhanced network architectures such as the I-HSPA and the LTE architectures. Hence, with the initial message a list of RNC-Ids can be provided to the core network, which list can include the RNC-Id of the base station through which the initial message is being sent from the user equipment to the core network element and the RNC-Ids of the neighboring base stations.

Hence, as described above, the initial message from the user equipment can be sent to the core network element via the base station serving the user equipment when the initial message is being sent. The base station can process the initial message in that it adds the information identifying the base station and its neighboring base stations, wherein the base station has readily configured the information identifying its neighboring base stations. The optimized area is then selected by the core network as the area to which the base station and the neighboring base stations—hence at least the two base stations—are assigned.

The initial message can be a part of the location update provided to the core element by the user equipment. In this case the paging assistance information element can be for example a new information element included in the RANAP initial user equipment message.

It can be seen as an advantage of this embodiment that it provides for a dynamic paging method in the following sense: The base station through which the initial message from the user equipment is being sent to the core network can be defined as a “centric” base station. Hence, the core network element can be provided within the initial message with the list comprising the RNC-Id of the centric base station and the RNC-Ids of its neighboring base stations. Based on this list the core network element can select the optimized area. If the user equipment moves, a new initial message can be sent from the user equipment, for example as a part of the location update, a new centric base can be defined. Therefore with the user equipment moving the optimized area can move as well.

According to a further embodiment of the invention the initial message comprises a service area identifier (SAI) information identifying the optimized area.

Using the service area identifier to identify the optimized area may use advantageously an already existing concept of a service area. The location area can consist of one or more service areas, wherein e.g. 6 to 8 base stations can be assigned to one service area. The service area identifier is used to identify the service area. The service area can be used for indicating a location of the user equipment to the core network. A Service Area Code (SAC) together with a Public Land Mobile Network Identifier (PLMN-Id) and a Location Area Code (LAC) can be at least a part of the service area identifier. The SAI can be defined and/or adjusted by an operator of the telecommunication network. For example, the RANAP initial user equipment message as specified in 3GPP TS 25.413 may comprise an information element indicating the SAI corresponding to the current location of the user equipment. Therefore, the existing Iu interface between the UTRAN and the core network has not to be changed. It can be seen as a further advantage of using the SAI that the corresponding file size will not be big.

When using the concept of the SAI, the optimized area is selected as the service area identified in the initial message sent from the user equipment to the core network element. Using the already exiting SAI concept can make the described method fully compatible with the existing technical standards of 3GPP.

According to a further embodiment of the invention the service area identifier information is mapped to an information identifying the at least two base stations being assigned the optimized area.

In order to use the service area identifier information effectively, the SAI included in the initial message can be mapped by the core network element to for example the RNC-Ids of the at least two base stations being assigned to the optimized area, which has been selected as the service area identified by the SAI. This can be of an advantage for the paging message being sent compliantly with the 3GPP specification from the core element to the at least two base stations being assigned to the optimized area. That way the existing Iu interface between the core network and the UTRAN as well the RANAP protocol used for the paging message can be used in an optimized manner.

According to a further embodiment of the invention an information content being included in the initial message is stored in the core network element.

It can be of an advantage to have the information content comprised in the initial message stored in the core network element, for example in the MSC and/or SGSN. A visitor location register, which can be an independent core network element or which can form one unit with the MSC, can be updated correspondingly. The stored information content can be for example the list of RNC-Ids of the base stations assigned to the optimized area. The stored information content can also comprise for example the SAI corresponding to the optimized area or RNC-Ids of the base stations assigned to the service area identified by the SAI. In general any information identifying the optimized area and/or the at least two base stations assigned to the optimized area can be stored in the core network element. This information can be used advantageously when there is a need for paging the user equipment within the telecommunication network in order to provide for the paging message effectively.

According to a further aspect of the invention there is provided a base station for a telecommunication network. The base station comprises a receiving unit for receiving a paging message from a core network element serving a location area being assigned to a user equipment. The base station further comprises a paging unit for paging the user equipment. The paging message is adapted to be received by the base station and a further base station, wherein the base station and the further base station are assigned to an optimized area, which has been selected within the location area. In addition to the base station also the further base station is adapted to page the user equipment.

Also this aspect of the present invention is based on the idea that the number of paging messages sent from one core element in order to page a user equipment within a telecommunication network can be decreased if only a subset of all base stations assigned to a location area assigned to the user equipment will be used for paging. Hence, a paging message from the core network element will be received not by all base stations assigned to the location area but only by those base stations assigned to the smaller optimized area within the location area.

The base station according to this aspect of the present invention can be used advantageously within evolved network architectures. This is because some functionalities, for example paging functionalities, of a radio network controller have been moved to the base station. The base station can take a form of an enhanced node B or an intelligent node B.

As a result the base station can be used in an effective and reliable manner for implementing the optimized method for paging a user equipment within enhanced 3G telecommunication networks like I-HPSA or LTE networks. A better utilization of radio network resources, base station resources and core network resources may be provided by the described method.

Optionally the base station can comprise a unit for receiving an initial message from the user equipment and a unit for processing the initial message in order to the initial message being adapted for selecting the optimized area. The base station can also comprise a further unit for sending the processed initial message to the core network element in order to the optimized area can be selected.

According to a further aspect of the invention there is provided a core network element serving a location area being assigned to a user element. The core network element comprises a selecting unit for selecting an optimized area within the location area, at least two base stations being assigned to the optimized area. The core network element further comprises a sending unit for sending a paging message to the at least two base stations. The paging message is adapted to initiate paging the user equipment from the at least two base stations.

Also this aspect of the present invention is based on the idea that the number of paging messages sent from one core element in order to page a user equipment within a telecommunication network can be decreased if only a subset of all base stations assigned to a location area assigned to the user equipment will be used for paging. Hence, a paging message from the core network element will be sent not to all base stations assigned to the location area but only those base stations assigned to the smaller optimized area within the location area.

The core network element according to this aspect of the present invention can be used advantageously within evolved network architectures, in which some functionalities, for example paging functionalities, of a radio network controller have been moved to the base station. The core network element can be a CS core network element, for example an MSC or a PS core network element, for example an SGSN or an MME.

As a result the core network element can be used in an effective and reliable manner for implementing the optimized method for paging a user equipment within enhanced 3G telecommunication networks like I-HPSA or LTE networks. A better utilization of radio network resources, base station resources and core network resources is provided by the described method.

Optionally the core network element can comprise a unit for mapping an information included in a initial message sent from the user equipment, which information is identifying the optimized area, into an information identifying the at least two base stations assigned to the optimized area.

According to a further aspect of the invention there is provided a telecommunication network for paging a user equipment. The telecommunication network comprises at least two base stations and a core network element according to above mentioned aspects of the invention.

The telecommunication network according to this aspect of the present invention can be employed to implement the method for paging a user equipment according the present invention in order to better utilize radio network resources, MSC resources and/or SGSN resources and/or MME resources. Hence, the network load between these core network entities and the UTRAN can be reduced.

As a result the telecommunication network can be used in an effective and reliable manner for implementing the optimized method for paging a user equipment within enhanced 3G telecommunication networks like I-HPSA or LTE networks in a way which can be fully compliant with the existing technical specifications of 3GPP.

According to a further aspect of the invention there is provided a computer program element for paging a user equipment within a telecommunication network. The computer program element, when being executed by a data processor, is adapted for controlling the method according to any of the above mentioned embodiments of the present invention.

The computer program element may be implemented as computer readable instruction code in any suitable programming language such as, for example, JAVA, C++. The instruction code is operable to program a computer or other programmable device to carry out the intended functions. The computer program element may be stored on a computer-readable medium such as for example a removable disk, a volatile or non-volatile memory, or an embedded memory/processor. The computer program element may also be available from a network, such as the WorldWideWeb, from which it may be downloaded.

The invention may be realized by means of a computer program element respectively software. However, the invention may also be realized by means of one or more specific electronic circuits respectively hardware. Furthermore, the invention may also be realized in a hybrid form, i.e. in a combination of software modules and hardware modules.

In the following there will be described exemplary embodiments of the present invention with reference to a method for paging a user equipment within a telecommunication network. It has to be pointed out that of course any combination of features relating to different subject matters is also possible.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered as to be disclosed with this application.

The aspects defined above and further aspects of the present invention are apparent from the examples of embodiments to be described hereinafter and are explained with reference to the examples of embodiments. The invention will be described in more detail hereinafter with reference to examples of embodiments but to which the invention is not limited.

### BRIEF DESCRIPTION OF THE DRAWINGS

FIG. 1 shows a telecommunication network for implementing a method for paging a user equipment within the telecommunication network

FIG. 2 shows steps of a method of paging a user equipment within a telecommunication network.

### DETAILED DESCRIPTION

The illustrations in the drawings are schematic. It is noted that in different figures, similar or identical elements are provided with reference signs, which are different from the corresponding reference signs only within the first digit.

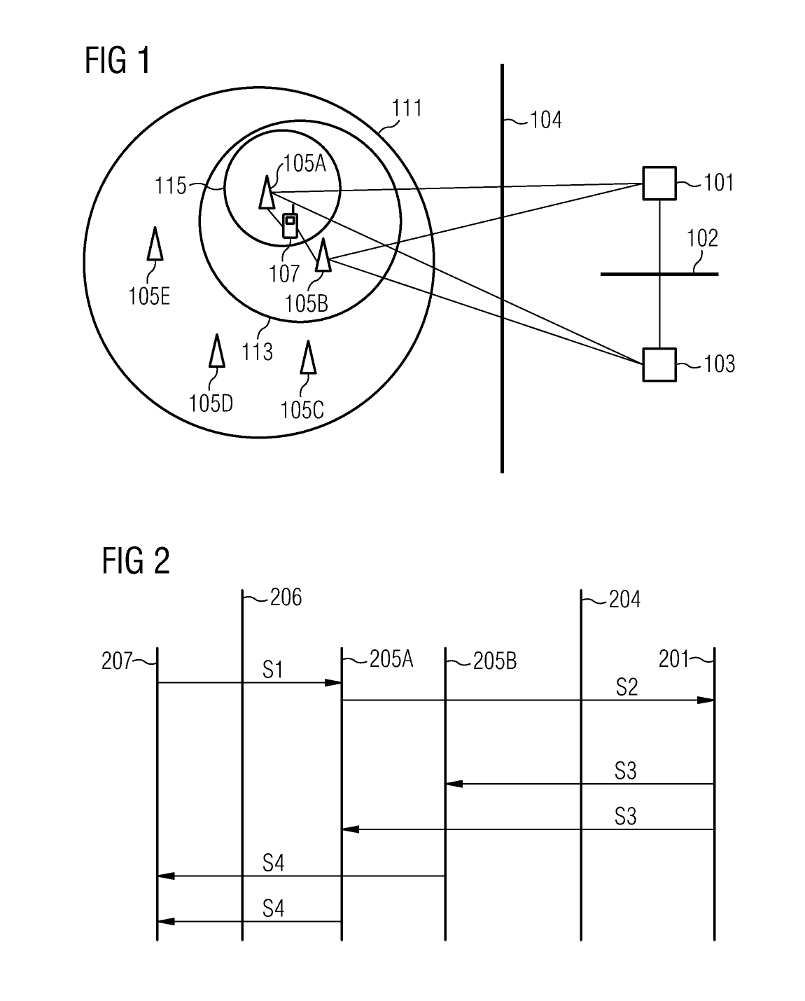

FIG. 1 shows a telecommunication network for implementing a method for paging a user equipment within the telecommunication network. It should be noted that only network elements that might directly be used for the paging method according to present are show in FIG. 1. The telecommunication network comprises a Mobile Switching Center (MSC) 101. The MSC as illustrated in FIG. 1 can be combined in one unit with a Visitor Location Register (VLR) 101. Alternatively the VLR can form an independent unit communicating with the MSC via an appropriate interface. The MSC 101 can belong to a not shown core network of the telecommunication network, in particular the MSC 101 can belong to a circuit-switched (CS) domain of the core network. Hence, the MSC 101 is an example of a core network element in particular an example of a CS core network element.

The core network of the telecommunication network further comprises a Serving General Packet Radio Service Support Node (SGSN) 103, which can belong to a packet-switched (PS) domain of the core network. Hence, the SGSN 103 is an example of a core network element in particular an example of a PS core network element. The SGSN 103 and MSC 101 can communicate over a signaling interface (Gs) 102. With the Gs 102 for example location updates and the paging of a user equipment within a telecommunication network may be handled through only one of the core network elements, for example the SGSN 103 only.

The telecommunication network further comprises two base stations (BS) 105A and 105B. The telecommunication network can comprise also further base stations as for example base stations 105C, 105D and 105E shown on FIG. 1.

The base stations 105A to 105E can form for example a part of a Universal Mobile Telecommunication System (UMTS) terrestrial radio access network (UTRAN) as specified by technical specifications of 3GPP. The base stations 105A to 105E can be assigned to a location area 111 of a user equipment 107. The location area 111 can either be identical with or at least partially independent of a location area, which has already been defined within some existing 2G or 3G network not being based on an enhanced architecture. In general any natural number N greater or equal two of base stations is possible.

The base stations 105A to 105E can communicate to the CS domain of the core network via a standard Iu 104 interface in the control plane for example over a SIGTRAN protocol as standardized by 3GPP technical specifications. For paging purposes, such a for example sending a paging message from the MSC and/or SGSN to the base stations 105A and 105B, for example a Radio Access Network Application Protocol (RANAP) can be user over the Iu interface.

The base stations 105A to 105E can be for example enhanced node Bs (eNB) also known as intelligent node Bs (iNB) which are used within enhanced mobile communication networks such as for example enhanced High Speed Downlink Packet Access (I-HSPA) or Long Term Evolution (LTE) networks. In particular the base stations 105A to 105E comprise implemented paging functionalities of Radio Network Controllers (RNC) used for example in earlier HSPA networks. A single base station such as for example the base station 105A serves one coverage area 115 of the base station. Coverage areas of the other base stations 105B to 105E are not shown explicitly in FIG. 1.

The user equipment (UE) 107 can communicate with the UTRAN via one of the base stations 105A to 105E over for example a Uu interface (not shown), for example via the base station 105A as illustrated by FIG. 1, which basis station is assigned to the current location area 111 of the user equipment 207. The RANAP protocol for the Iu interface can also be used for an indirect communication between the user equipment 107 and the core element, for example the MSC 101 and/or SGSN 103 via the base station 105A. For example a RANAP initial UE message can be sent to the MSC 101 and/or SGSN 103 via the base station 105A from the user equipment.

As already mentioned, the base stations 105A to 105 E are assigned to the location area 111 of the user equipment. In FIG. 1 the location area 111 comprises an optimized area 113 to which the base stations 105A and 105B are assigned. Although in FIG. 1 the two base stations 105A and 105B are assigned to the optimized area 113, in general any natural number M greater or equal than two and smaller than N, where N is the number of base stations assigned to the location area 111, is possible. The base station 105A can readily have configured information about the other base station 105B, which is assigned to the same optimized area. If there will be in addition to the base stations 105A and 105B also M-2 other base stations assigned to the same optimized area 113 the base station 105A can readily have configured information about all its neighboring base stations, i.e. all the other M-1 base stations assigned to the optimized area 113.

In this respect it should be noted that a base station such as for example the base station 105A can have configured information about one or more base stations 105B to 105E in order to be able to perform relocations, which information can be utilized to select the optimized area 113. In this case it is however not necessary that all of base stations, for which base stations the information for relocation purposes has been configured in the base station 105A, will also be assigned to the optimized area 113. For example, the base station 105A can have configured for relocation purposes the information about base stations 105B and 10C but only the base station 105B can be assigned—together with the base station 105A—to the optimized area 113.

Further, the optimized area 113 can be identical with a service area identified with a Service Area Identifier (SAI), which can be defined and/or adjusted by an operator of the telecommunication network.

Although the telecommunication network has been described in detail with respect to an enhanced High Speed Packet Access (I-HSPA, also known as HSPA evolution, HSPA+ or Internet HSPA) flat architecture as specified by 3GPP Rel-7, it will be clear to a skilled person that the telecommunication network can be based on some other enhanced network architecture, for example on a 3GPP Long Term Evolution (LTE) flat architecture as defined in 3GPP Rel-8. In the latter case a Mobility Management Entity (MME) can be used instead of the SGSN.

FIG. 2 shows steps of a method of paging a user equipment within a telecommunication network.

The method of paging a user equipment will be described with reference to an optimized area to which two base stations are assigned 205A and 205B, i.e. the base station 205A and its neighboring base station 205B. However any number M of base stations greater or equal than two assigned to the optimized area such as optimized area 113 in FIG. 1 is possible. The following description modifies accordingly.

In a first optional step S1 an initial message is sent from a user equipment 207 to a base station 205A over for example a Uu interface 206. The base station 205A is serving the user equipment 207 at the moment when the initial message is being sent out, i.e. at this moment the user equipment 207 is located within a coverage area 115 (see FIG. 1) of the base station 205A. Further, in the step S1 the initial message can be received and processed by the base station 205A. In a following optional step S2 the initial message can be sent over an Iu interface 204 to a core network element 201 such as the MSC and/or the SGSN. If the initial message is sent only to one network element 201, for example to the SGSN and a signaling interface (Gs) has been set up between the SGSN and for example the MSC the initial message can be also forwarded from the SGSN to MSC. Such a combined CS/PS location update procedure using the Gs is specified in e.g. 3GPP TS 23.060 and 3GPP TS 29.018. Also in the step S2 an information content comprised in the initial message can be stored in the core network element 201.

Further, in the described embodiment of the present invention the base station 205A can readily have configured information about its neighboring base station 205B, in which case the base stations 205A and 205B can be assigned to the same optimized area. In such a case the base station 205A can be referred to as a centric base station. Thus when the initial message is sent from the user equipment 207 via the base station 205A to the core network element 201 in the optional steps S1 and S2, this initial message can be processed in the step S1 by the base station 205A in order an information identifying the centric base stations 205A and its neighboring station 205 B to be included into an identification information element of the initial message. For example the identification information element can be a new paging assistance information element of the initial message based on the RANAP protocol.

The paging assistance information element can comprise the identification information identifying the centric base station 205A in a form of a Radio Network Controller Identifier (RNC-Id) of the base station 205A. Also the paging assistance information element can comprise the identification information identifying the neighboring base station 205B in a form of its RNC-Id.

In this respect it should be noted that an identification of the base stations 205A and 205B based on their RNC-Ids is possible due to the fact that some RNC functionalities have been moved to the base stations—the enhanced node Bs—in the enhanced network architectures such as I-HSPA and/or LTE architectures. Hence with the initial message a list of RNC-Ids can be provided to the core network element 201, which list can include an RNC-Id of the centric base station 205A through which the initial message is being sent from the user equipment 207 to the core network element 201 and the RNC-Id of its neighboring base station 205B.

In an another embodiment of the method of the present invention the location area 111 can comprise one or more service areas, wherein e.g. 6 to 8 base stations like 205A and 205B can be assigned to one service area. A service area identifier (SAI) is used to identify the service area. The service area can be used for indicating the location of the user equipment to the core network. A Service Area Code (SAC) together with a Public Land Mobile Network Identifier (PLMN-Id) and a Location Area Code (LAC) can be included in the service area identifier. The SAI can be defined and/or adjusted by an operator of the telecommunication network. The initial message sent in the steps S1 and S2, for example the RANAP initial user equipment message as specified in 3GPP TS 25.413, can comprise an information element indicating the SAI corresponding to a current location of the user equipment 207. If this is the case the information included in SAI can be mapped to an information identifying the two base stations 205A and 205B, for example to the RNC-Ids of these base stations in step S2.

The initial message can be a part of a location update provided to the core element 201 by the user equipment 207. In this case the paging assistance information element can be for example a new information element included in the RANAP initial user equipment message.

When the core network element 201 receives a service request, for example a voice call or a short message for the user equipment 207, the core network element 201 selects an optimized area, such as the optimized area 113 within the location area 111 (see FIG. 1) and sends a paging message to the base stations 205A and 205B assigned to the optimized area 113 in step S3. The paging message can be send to the base stations 205A and 205B directly over the Iu interface 204. The paging message can also be sent from the core network element 201, for example the MSC first to another network element, for example an SGSN over the Gs interface and then after a possible processing to the base stations 205A and 205B. Hence, a possible redundancy of sending independent paging messages from CS and PS domains of the telecommunication network simultaneously can be avoided when the Gs interface exists between the MSC and SGSN. The paging message can be a RANAP based message as specified by 3GPP TS 25.413, where information elements comprised in the RANAP paging message are described. The RANAP paging message can be processed by the SGSN and/or the MSC in dependence on a packet mobility management (PMM) state—defined in 3GPP TS 23.060 of the—paged user equipment.

The selection of the optimized area in step S3 can be based for example on the initial message sent to the core network element 201 from the user equipment 207 via the base station 205A in optional steps S1 and S2. If this is the case the core network element 201 can use the information content included in the initial message to select the optimized area 113. As already mentioned above this information content could have been stored for paging purposes in the core network element 201, for example in the MSC/VLR or in the SGSN in the optional step S2. Further, this information content can comprise for example the information identifying the base station 205A and 205B such as their respective RNC-Ids included in the identification information element of the initial message. However, this information content can comprise the SAI information included in the initial message. Also, this information content can be the information identifying the base station 205A and 205B, which information has been obtained by a mapping from the SAI information included in the initial message. Such an information identifying the base station 205A and 205B can be again for example the RNC-Ids of these base stations.

Also in step S3 the paging message from the core network element 201 will be received by the base stations 205A and 205B assigned to the selected optimized area 113.

In step S4 a broadcasting of a standard paging message by the base stations 205A and 205B will be initiated—based on the paging message sent from the core network element and received by the base stations 205A and 205B—in order to identify the user equipment 207, which broadcasting is referred to as the paging of the user equipment 207 from the base stations 205A and 205B. This paging of the user equipment can be carried out over the Uu interface 206.

Although the steps of the described paging method have been described in detail with respect to an enhanced High Speed Packet Access (I-HSPA, also known as HSPA evolution, HSPA+ or Internet HSPA) flat architecture as specified by 3GPP Rel-7, it will be clear to a skilled person that the paging method of the present invention can be easily adapted to be implemented within other enhanced network architectures, for example on a 3GPP Long Term Evolution (LTE) flat architecture as defined in 3GPP Rel-8. In the latter case a Mobility Management Entity (MME) can be used instead of the SGSN.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

### List of Reference Signs

101 Mobile Switching Center/Visitor Location Register
102 Signaling Interface Gs
103 Serving General Packet Radio Service Support Node
104 Iu Interface
105A to D Base Station
107 User Equipment
111 Location Area
113 Optimized Area
115 Coverage Area
201 Core Network Element
204 Iu Interface
205A and B Base Station
206 Uu Interface
207 User Equipment

1-14. (canceled)

15. A method for paging user equipment within a telecommunication network, which comprises the steps of:
selecting an optimized area within a location area being assigned to the user equipment, at least two base stations being assigned to the optimized area;
sending a paging message from a core network element serving the location area to the at least two base stations; and
paging the user equipment from the at least two base stations being assigned to the optimized area.

16. The method according to claim 15, which further comprises providing the at least two base stations as enhanced node Bs.

17. The method according to claim 15, which further comprises providing the core network element as a mobile switching center and/or a serving general packet radio service node.

18. The method according to claim 15, which further comprises basing the paging message on a radio access network application protocol.

19. The method according to claim 15, wherein the step of selecting the optimized area further comprises sending an initial message from the user equipment to the core network element.

20. The method according to claim 19, which further comprises basing the initial message on a radio access network application protocol.

21. The method according to claim 19, which further comprises providing the initial message with an identification information element, the identification information element containing information identifying the at least two base stations being assigned to the optimized area.

22. The method according to claim 19, which further comprises providing the initial message with service area identifier information identifying the optimized area.

23. The method according to claim 22, wherein the service area identifier information is mapped to information identifying the at least two base stations being assigned to the optimized area.

24. The method according to claim 19, which further comprises storing information content included in the initial message in the core network element.

25. A base station for a telecommunication network, the base station comprising:
a receiving unit for receiving a paging message from a core network element serving a location area being assigned to user equipment; and
a paging unit for paging the user equipment, the paging message adapted to be received by the base station and a further base station, the base station and the further base station are assigned to an optimized area, which has been selected within the location area, and the further base station is adapted to page the user equipment.

26. A core network element serving a location area being assigned to a user element, the core network element comprising:
a selecting unit for selecting an optimized area within the location area, at least two base stations being assigned to the optimized area; and
a sending unit for sending a paging message to the at least two base stations, the paging message being adapted to initiate paging the user equipment from the at least two base stations.

27. A telecommunication network for paging user equipment, the telecommunication network comprising:
a core network element;
at least two base stations including a first base station and a second base station, each of said base stations containing:
a receiving unit for receiving a paging message from said core network element serving a location area being assigned to the user equipment; and
a paging unit for paging the user equipment, the paging message adapted to be received by said first base station and said second base station, said first base station and said second base station are assigned to an optimized area, which has been selected within the location area, and said second base station being adapted to page the user equipment;
said core network element containing:
a selecting unit for selecting the optimized area within the location area, said at least two base stations being assigned to the optimized area; and
a sending unit for sending the paging message to said at least two base stations, the paging message being adapted to initiate paging the user equipment from said at least two base stations.

28. A computer-readable medium having computer executable instructions for paging user equipment within a telecommunication network, the computer-readable medium, when executed by a data processor, is adapted for controlling a method for paging the user equipment, the method comprises the steps of:
selecting an optimized area within a location area being assigned to the user equipment, at least two base stations being assigned to the optimized area;
sending a paging message from a core network element serving the location area to the at least two base stations; and
paging the user equipment from the at least two base stations being assigned to the optimized area.
